(19) United States
(12) Patent Application Publication
(10) Pub. No.: US 2022/0311007 A1
(43) Pub. Date: Sep. 29, 2022

(54) POSITIVE ELECTRODE FOR LITHIUM ION SECONDARY BATTERY AND LITHIUM ION SECONDARY BATTERY

(71) Applicant: TDK CORPORATION, Tokyo (JP)

(72) Inventors: Hiroki KARISYUKU, Tokyo (JP); Takashi MORI, Tokyo (JP); Yasuhide YAMASHITA, Tokyo (JP); Kotaro TERAO, Tokyo (JP)

(21) Appl. No.: 17/699,881

(22) Filed: Mar. 21, 2022

(30) Foreign Application Priority Data
Mar. 23, 2021 (JP) 2021-048345

(51) Int. Cl. H01M 4/62; H01M 4/131; H01M 10/0525

(52) U.S. Cl. CPC H01M 4/625; H01M 4/131; H01M 10/0525; H01M 2004/028

(57) ABSTRACT

A positive electrode for a lithium ion secondary battery includes a current collector and a positive electrode active material layer in contact with at least one surface of the current collector, wherein the positive electrode active material layer contains a plurality of positive electrode active materials and a plurality of fibrous carbons, the positive electrode active material layer has a plurality of pores therein, at least a part of the plurality of fibrous carbons is intertwined with each other to form a carbon network, and the carbon network is formed on a surface facing one of the plurality of pores.

### BACKGROUND OF THE INVENTION

### Field of the Invention

The present invention relates to a positive electrode for a lithium ion secondary battery and a lithium ion secondary battery.

Priority is claimed on Japanese Patent Application No. 2021-048345 filed on Mar. 23, 2021, the content of which is incorporated herein by reference.

### Description of Related Art

Lithium ion secondary batteries are also widely utilized as a power source for mobile devices such as mobile phones and laptop computers and hybrid cars.

In recent years, there has been demand for lithium ion secondary batteries having a high energy density and excellent output characteristics. For example, Patent Document 1 describes a lithium ion secondary battery capable of minimizing an increase in internal resistance of a battery during charging/discharging under high output conditions.

### PATENT DOCUMENTS

[Patent Document 1] Japanese Unexamined Patent Application, First Publication No.2007-109636

### SUMMARY OF THE INVENTION

However, charging/discharge under high output conditions involves a large amount of heat generation at the time of output. Heat generation can cause various problems.

The present disclosure was made in view of the above problems, and an object of the present disclosure is to provide a positive electrode for a lithium ion secondary battery and a lithium ion secondary battery having excellent heat dissipation.

The inventors of the present invention have found that heat generation during high input/output can be prevented by forming a carbon network in which carbon fibers are folded at a prescribed position in a positive electrode active material. That is to say, in order to achieve the above object, the following means are provided.

(1) A positive electrode for a lithium ion secondary battery according to a first aspect includes a current collector and a positive electrode active material layer in contact with at least one surface of the current collector. The positive electrode active material layer contains a plurality of positive electrode active materials and a plurality of fibrous carbons, the positive electrode active material layer has a plurality of pores therein, at least some of the plurality of fibrous carbons are intertwined with each other to form a carbon network, and the carbon network is formed on a surface facing at least one of the plurality of pores.

(2) In the positive electrode for a lithium ion secondary battery according to the aspect, an average diameter of the plurality of fibrous carbon pieces may be 0.3 nm or more and 100 nm or less.

(3) In the positive electrode for a lithium ion secondary battery according to the aspect, an average diameter of the plurality of pores may be 0.5 μm or more and 5 μm or less.

(4) A lithium ion secondary battery according to a second aspect includes the positive electrode for a lithium ion secondary battery according to the above aspect.

The positive electrode for a lithium ion secondary battery and the lithium ion secondary battery according to the above aspect have excellent heat dissipation.

### BRIEF DESCRIPTION OF THE DRAWINGS

FIG. 1 is a schematic diagram of a lithium ion secondary battery according to a first embodiment.

FIG. 2 is a diagram of a part of a positive electrode active material layer according to the first embodiment captured through a scanning electron microscope.

FIG. 3 is a diagram of a composite powder prepared through a wet method captured through a scanning electron microscope.

FIG. 4 is a diagram of a composite powder prepared through a mechanochemical method captured through a scanning electron microscope.

### DETAILED DESCRIPTION OF THE INVENTION

Embodiments will be described in detail below with reference to the drawings as appropriate. In the drawings used in the following description, in order to make the features easier to understand, enlarged featured parts may be provided for convenience and dimensional ratios of constituent elements may differ from those of the actual constituent elements in some cases. The materials, the dimensions, and the like exemplified in the following description are examples, the present invention is not limited thereto, and the present invention can be appropriately modified and carried out without changing the gist of the present invention.

### “Lithium Ion Secondary Battery”

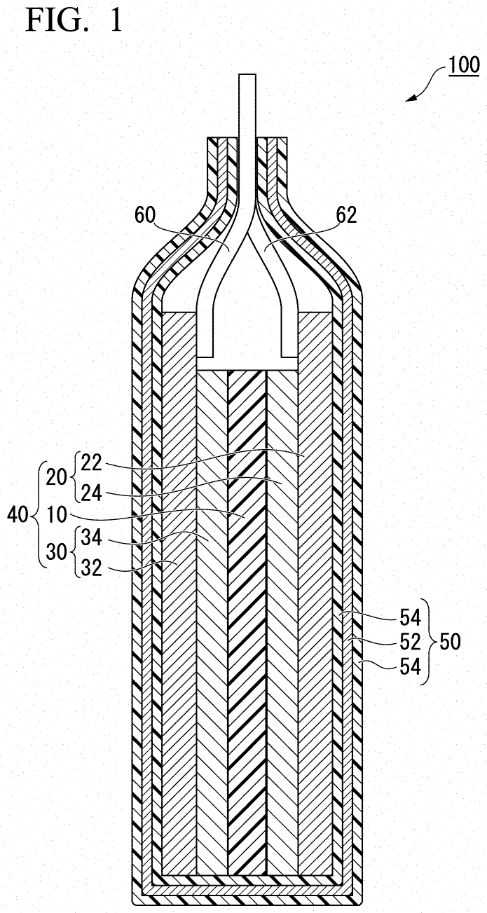

FIG. 1 is a schematic diagram of a lithium ion secondary battery according to a first embodiment. A lithium ion secondary battery 100 shown in FIG. 1 includes a power generation element 40, an exterior body 50, and a non-aqueous electrolytic solution (not shown). The periphery of the power generation element 40 is coated with the exterior body 50. The power generation element 40 is connected to the outside using a pair of terminals 60 and 62 which are connected. The non-aqueous electrolytic solution is accommodated in the exterior body 50.

### (Power Generation Element)

The power generation element 40 includes a positive electrode 20, a negative electrode 30, and a separator 10.

### <Positive Electrode>

The positive electrode 20 includes, for example, a positive electrode current collector 22 and a positive electrode active material layer 24. The positive electrode active material layer 24 is in contact with at least one surface of the positive electrode current collector 22.

### [Positive Electrode Current Collector]

The positive electrode current collector 22 is, for example, a conductive sheet material. The positive electrode current collector 22 is, for example, a thin metal sheet of such as aluminum, copper, nickel, titanium, or stainless steel. An average thickness of the positive electrode current collector 22 is, for example, 10 μm or more and 30 μm or less.

### [Positive Electrode Active Material Layer]

The positive electrode active material layer 24 contains, for example, a plurality of positive electrode active material pieces and a plurality of fibrous carbon pieces. In addition to this, the positive electrode active material layer 24 may contain a conductive auxiliary agent, a binder, a lithium compound, and the like. Furthermore, there are a plurality of pores inside the positive electrode active material layer 24. The pores are located, for example, between a plurality of positive electrode active materials.

Each of the positive electrode active materials is an electrode active material allowing reversible progression of the occlusion and release of lithium ions, the desorption and insertion (intercalation) of lithium ions, or the doping and dedoping of lithium ions and counter anions.

The positive electrode active material is, for example, a composite metal oxide. Examples of the composite metal oxide include lithium cobaltate (LiCoO₂), lithium nickelate (LiNiO₂), lithium manganate (LiMnO₂), lithium manganese spinel (LiMn₂O₄), a compound of general expression: LiNiₓCo_{y}Mn_{z}MₐO₂ (in the general expression, x+y+z+a=1, 0≤x<1, 0≤y<1, 0≤z<1, and 0≤a<1, and M is one or more elements selected from Al, Mg, Nb, Ti, Cu, Zn, and Cr), a lithium vanadium compound (LiV₂O₅), olivine type LiMPO₄ (where M indicates one or more elements selected from Co, Ni, Mn, Fe, Mg, Nb, Ti, Al, and Zr or VO), lithium titanate (Li₄Ti₅O₁₂), and LiNiₓCo_{y}Al_{z}O₂ (0.9<x+y+z<1.1). The positive electrode active material may be an organic substance. For example, the positive electrode active material may be polyacetylene, polyaniline, polypyrrole, polythiophene, or polyacene.

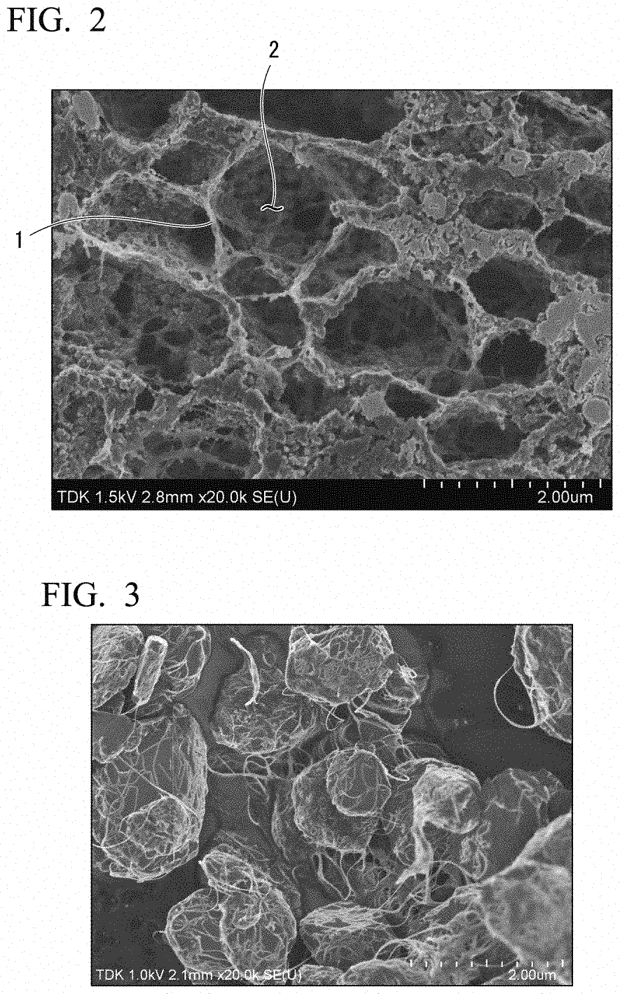

FIG. 2 is a photo of a part of the positive electrode active material layer 24 of the lithium ion secondary battery 100 according to the first embodiment captured through a scanning electron microscope (SEM).

As shown in FIG. 2, there are a plurality of fibrous carbons 1 in the positive electrode active material layer 24. The plurality of fibrous carbons 1 are intertwined with each other. The other fibrous carbons 1 are crosslinked through each of the fibrous carbons 1. The fibrous carbons 1 are in physical contact with each other. Each of the fibrous carbons 1, for example, intersects others.

The fibrous carbon 1 functions as a conductive auxiliary agent for the positive electrode active material layer 24. The conductive auxiliary agent enhances the electron conductivity between the positive electrode active materials. The term “fibrous-shaped” mentioned herein means an object whose length is 50 times or more a diameter thereof. The fibrous carbon 1 is, for example, a carbon nanotube. The carbon nanotube may be a nanotube of a single layer or a multi-layer.

An average diameter of the fibrous carbon 1 is, for example, 0.3 nm or more and 150 nm or less, preferably 0.3 nm or more and 100 nm or less, and more preferably 0.6 nm or more and 100 nm or less. A diameter of the fibrous carbon 1 is a diameter of a cross section orthogonal to a length direction of the fibrous carbon 1. For example, an average thickness of any 50 fibrous carbons confirmed through a scanning electron microscope is an average diameter of the fibrous carbons. When the fibrous carbon 1 can be analyzed and evaluated before the preparation of the positive electrode active material layer 24, the fibrous carbon 1 can be specifically designated.

An average length of the fibrous carbons 1 is, for example, 0.1 μm or more and 100 μm or less, and preferably 1 μm or more and 30 μm or less. The average length of the fibrous carbons 1 is obtained as an average value of 50 fibrous carbons measured through a scanning electron microscope. When the fibrous carbon 1 before the preparation of the positive electrode active material layer 24 can be specifically designated, the fibrous carbon 1 is analyzed and evaluated.

Many of fibrous carbons 1 included in the positive electrode active material layer 24 are, for example, not bundled, but exist separately. For example, 50% or more of the fibrous carbon 1 which can be confirmed in a photo captured through a scanning electron microscope (SEM) in which at least 10 pores 2 which will be described later can be confirmed is not bundled. If an exterior form of one of the fibrous carbon pieces 1 can be confirmed not to be crushed, it can be determined that this fibrous carbon piece 1 is not bundled.

At least some of the plurality of fibrous carbons 1 are intertwined with each other to form a carbon network. A unit structure constituting the carbon network is each of the fibrous carbons 1. The carbon network is in a state in which the fibrous carbons 1 form a network structure.

Also, carbon networks are intricately intertwined with each other and include a pore 2 therein. The carbon networks form a carbon skeleton which surrounds the pore 2. The carbon networks are formed, for example, in a cage shape, a nest shape, or an outer shell shape. A plurality of pores 2 are formed in a portion surrounded by the carbon networks. The carbon networks are formed on a surface facing at least one of the plurality of pores 2.

An average diameter of the pores 2 is, for example, 0.5 μm or more and 10 μm or less, preferably 0.5 μm or more and 8 μm or less, and more preferably 1.0 μm or more and 5 μm or less. The average diameter of the pores 2 is an average diameter of 50 arbitrary pores 2 which can be confirmed in a photo captured through a scanning electron microscope. A diameter of each of the pores 2 is an average of a long-axis length and a short-axis length of the pore 2 in a cross-sectional image.

The binder binds the active materials together. As the binder, a known binder can be utilized. The binder is, for example, a fluororesin. Examples of the fluororesin include polyvinylidene fluoride (PVDF), polytetrafluoroethylene (PTFE), a tetrafluoroethylene-hexafluoropropylene copolymer (FEP), a tetrafluoroethylene-perfluoroalkyl vinyl ether copolymer (PFA), ethylene-tetrafluoroethylene copolymer (ETFE), polychlorotrifluoroethylene (PCTFE), ethylene-chlorotrifluoroethylene copolymer (ECTFE), polyvinyl fluoride (PVF), and the like.

In addition to the above, examples of the binder include a vinylidene fluoride fluororubber such as vinylidene fluoride-hexafluoropropylene-based fluororubber (VDF-HFP-based fluororubber), vinylidene fluoride-hexafluoropropylene-tetrafluoroethylene-based fluororubber (VDF-HFP-TFE-based fluororubber), vinylidenefluoride-pentafluoropropylene-based fluororubber (VDF-PFP-based fluororubber), vinylidene fluoride-pentafluoropropylene-tetrafluoroethylene-based fluororubber (VDF-PFP-TFE-based fluororubber), vinylidenefluoride-perfluoromethyl vinyl ether-tetrafluoroethylene-based fluorine rubber (VDF-PFMVE-TFE-based fluorine rubber), and vinylidene fluoride-chlorotrifluoroethylene-based fluorine rubber (VDF-CTFE-based fluorine rubber). Furthermore, the binder may be, for example, cellulose, a styrene/butadiene rubber, an ethylene/propylene rubber, a polyimide resin, a polyamide-imide resin, an acrylic resin, or the like.

The conductive auxiliary agent may be added separately in addition to the fibrous carbon. The conductive auxiliary agent is, for example, a carbon powder such as carbon black, acetylene black, and ketjen black, carbon nanotubes, a carbon material, a fine metal powder such as copper, nickel, stainless steel, and iron, a mixture of a carbon material and a fine metal powder, or a conductive oxide such as ITO. It is preferable that the conductive auxiliary agent be a carbon material such as carbon black, acetylene black, or ketjen black.

The lithium compound is, for example, a support at the time of forming a carbon network, which remains without completely removed. The lithium compound is used, for example, for forming pores. Although a lot of lithium compound is removed by cleaning a positive electrode before charging and discharging, some may remain as a residue in some cases. Cleaning of the positive electrode is performed, for example, with a solvent capable of dissolving the lithium compound. For example, when the lithium compound is lithium hydroxide, lithium carbonate, lithium chloride, or the like, a lot of lithium compound is removed by performing washing with excess water.

The lithium compound is, for example, at least one selected from the group consisting of lithium fluoride (LiF), lithium oxalate (LiOOCCOOLi), lithium acetate (CH₃CO₂Li), lithium nitrate (LiNO₃), lithium oxide (Li₂O), lithium peroxide (Li₂O₂), lithium carbonate (C₆Li), lithium hydroxide (LiOH), lithium carbonate (Li₂CO₃), lithium chloride (LiCl), lithium iodide (LiI), and lithium nitride (Li₃N). Among these, the lithium compound is preferably lithium carbonate, lithium hydroxide, or lithium iodide, and lithium carbonate is particularly preferable.

### <Negative Electrode>

The negative electrode 30 includes, for example, a negative electrode current collector 32 and a negative electrode active material layer 34. The negative electrode active material layer 34 is formed on at least one surface of the negative electrode current collector 32.

### [Negative Electrode Current Collector]

The negative electrode current collector 32 is, for example, a conductive sheet material. As the negative electrode current collector 32, the same collector as that of the positive electrode current collector 22 can be utilized.

### [Negative Electrode Active Material Layer]

The negative electrode active material layer 34 contains a negative electrode active material. Furthermore, if necessary, a conductive auxiliary agent, a binder, and a solid electrolyte may be contained.

The negative electrode active material may be any compound which can occlude and release ions and a known negative electrode active material used in a lithium ion secondary battery can be utilized. The negative electrode active material is, for example, particles containing metallic lithium, a lithium alloy, a carbon material such as graphite capable of occluding and releasing ions (natural graphite, artificial graphite), a carbon nanotube, non-graphitizable carbon, graphitizable carbon, and low temperature fired carbon, a metal such as aluminum, silicon, tin, and germanium which can be combined with a metal such as lithium, an amorphous composite mainly composed of an oxide such as SiOₓ (0<x<2) and tin dioxide, lithium titanate (Li₄Ti₅O₁₂), or the like.

The negative electrode active material layer 34 may contain silicon, tin, and germanium. Silicon, tin, and germanium may exist as a single element or as a compound. The compound is, for example, an alloy, an oxide, or the like. As an example, when the negative electrode active material is silicon, the negative electrode 30 may be referred to as a Si negative electrode in some cases. The negative electrode active material may be, for example, elemental silicon, tin, or germanium, or a mixture of a compound and a carbon material. The carbon material is, for example, natural graphite. Furthermore, the negative electrode active material may be, for example, a simple substance of silicon, tin, germanium or a compound whose surface is coated with carbon. The carbon material and the coated carbon enhance the conductivity between the negative electrode active material and the conductive auxiliary agent. If the negative electrode active material layer contains silicon, tin, and germanium, the capacity of the lithium ion secondary battery 100 increases.

The negative electrode active material layer 34 may contain, for example, lithium as described above. Lithium may be metallic lithium or a lithium alloy. The negative electrode active material layer 34 may be metallic lithium or a lithium alloy. The lithium alloy is, for example, an alloy of one or more elements selected from the group consisting of Si, Sn, C, Pt, Ir, Ni, Cu, Ti, Na, K, Rb, Cs, Fr, Be, Mg, Ca, Sr, Sb, Pb, In, Zn, Ba, Ra, Ge, and Al and lithium. As an example, when the negative electrode active material is metallic lithium, the negative electrode 30 may be referred to as a Li negative electrode in some cases. The negative electrode active material layer 34 may be a lithium sheet.

The negative electrode 30 may be only the negative electrode current collector 32 without having the negative electrode active material layer 34 at the time of preparation. When the lithium ion secondary battery 100 is charged with electricity, metallic lithium is deposited on a surface of the negative electrode current collector 32. The metallic lithium is elemental lithium in which lithium ions are deposited and the metallic lithium functions as the negative electrode active material layer 34.

As the conductive auxiliary agent and the binder, the same conductive auxiliary agent and binder as those of the positive electrode 20 can be utilized. The binder in the negative electrode 30 may be, for example, cellulose, a styrene/butadiene rubber, an ethylene/propylene rubber, a polyimide resin, a polyamide-imide resin, an acrylic resin, or the like, in addition to those listed in the positive electrode 20. Cellulose may be, for example, carboxymethyl cellulose (CMC).

### <Separator>

The separator 10 is disposed between the positive electrode 20 and the negative electrode 30. The separator 10 isolates the positive electrode 20 and the negative electrode 30 and prevents a short circuit between the positive electrode 20 and the negative electrode 30. The separator 10 extends in a plane along the positive electrode 20 and the negative electrode 30. Lithium ions can pass through the separator 10.

The separator 10 has, for example, an electrically insulating porous structure. Examples of the separator 10 include a single-layered body formed of a film made of a polyolefin such as polyethylene or polypropylene, a laminated body, or a stretched film formed of a mixture of the above resins or a fibrous nonwoven fabric made of at least one constituent material selected from the group consisting of cellulose, polyester, polyacrylonitrile, polyamide, polyethylene, and polypropylene. The separator 10 may be, for example, a solid electrolyte. The solid electrolyte is, for example, a polymer solid electrolyte, an oxide-based solid electrolyte, or a sulfide-based solid electrolyte.

### (Terminal)

The terminals 60 and 62 are connected to the positive electrode 20 and the negative electrode 30, respectively. The terminal 60 connected to the positive electrode 20 is a positive electrode terminal, and the terminal 62 connected to the negative electrode 30 is a negative electrode terminal. The terminals 60 and 62 are responsible for electrical connection with the outside. The terminals 60 and 62 are formed of a conductive material such as aluminum, nickel, and copper. The connection method may be welding or screwing. It is preferable to protect the terminals 60 and 62 with an insulating tape to prevent a short circuit.

(Exterior body)

The exterior body 50 seals the power generation element 40 and the non-aqueous electrolytic solution therein. The exterior body 50 prevents leakage of the non-aqueous electrolytic solution to the outside and introduction of water and the like into the inside of the lithium ion secondary battery 100 from the outside.

The exterior body 50 has, for example, as shown in FIG. 1, a metal foil 52 and a resin layer 54 laminated on each surface of the metal foil 52. The exterior body 50 is a metal laminate film in which a metal foil 52 is coated from both sides with a polymer film (resin layer 54).

As the metal foil 52, for example, an aluminum foil can be utilized. A polymer film such as polypropylene can be utilized for the resin layer 54. A material constituting the resin layer 54 may be different between the inside and the outside. For example, a polymer having a high melting point, for example, polyethylene terephthalate (PET), polyamide (PA), or the like can be utilized as an outer material and polyethylene (PE), polypropylene (PP), or the like can be utilized as a material for an inner polymer film.

### (Non-Aqueous Electrolytic Solution)

The non-aqueous electrolytic solution is sealed in the exterior body 50 and impregnated in the power generation element 40. The non-aqueous electrolyte solution has, for example, a non-aqueous solvent and an electrolyte. The electrolyte is dissolved in a non-aqueous solvent.

The non-aqueous solvent contains, for example, a cyclic carbonate and a chain carbonate. The cyclic carbonate solvates the electrolyte. The cyclic carbonate is, for example, ethylene carbonate, propylene carbonate, or butylene carbonate. It is preferable that the cyclic carbonate contain at least propylene carbonate. The chain carbonate reduces the viscosity of the cyclic carbonate. The chain carbonate is, for example, diethyl carbonate, dimethyl carbonate, or ethyl methyl carbonate. The non-aqueous solvent may also include methyl acetate, ethyl acetate, methyl propionate, ethyl propionate, propyl propionate, γ-butyrolactone, 1,2-dimethoxyethane, 1,2-diethoxyethane, and the like.

A ratio of cyclic carbonate to chain carbonate in the non-aqueous solvent is preferably 1:9 to 1:1 in volume.

The electrolytic solution contains, for example, fluoroethylene carbonate and vinylene carbonate. Fluoroethylene carbonate and vinylene carbonate inhibit the decomposition of the electrolytic solution on the surface of the lithium compound.

A ratio of fluoroethylene carbonate in the electrolytic solution and a ratio of vinylene carbonate in the electrolytic solution satisfy 0.001<Y/X<0.01. Here, X is the ratio of fluoroethylene carbonate in the electrolytic solution, and Y is the ratio of vinylene carbonate in the electrolytic solution.

The ratio X of the fluoroethylene carbonate in the electrolytic solution is, for example, 20 wt % or less and may be 5 wt % or more and 20 wt % or less. The ratio Y of vinylene carbonate in the electrolytic solution is, for example, 0.05 wt % or less and may be 0.005 wt % or more and 0.5 wt % or less.

The electrolyte is, for example, a lithium salt. The electrolyte is, for example, LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, or the like. One type of lithium salt may be used alone, or a combination of two or more types may be used. From the viewpoint of the degree of ionization, it is preferable that the electrolyte contain LiPF₆.

### “Method for Producing Lithium Ion Secondary Battery”

The positive electrode 20 is obtained by coating at least one surface of the positive electrode current collector 22 with a paste-like positive electrode slurry (coating film) and drying the positive electrode slurry (coating film). As the positive electrode current collector 22, a commercially available product can be utilized.

The method for applying the positive electrode slurry is not particularly limited. For example, a slit die coat method and a doctor blade method can be utilized as a method for applying the positive electrode slurry.

When the positive electrode slurry is prepared, the positive electrode active material, the binder, the composite powder, and the solvent are mixed. In the composite powder, fibrous carbon is clinging to the surface of the lithium compound and is intertwined with each other.

The composite powder is produced, for example, through a wet method. For example, when the lithium compound is immersed in a dispersion liquid in which fibrous carbon is dispersed, fibrous carbon adheres to the surface of the lithium compound. A resin layer may be formed on the surface of the lithium compound to improve the adhesiveness of the fibrous carbon. Furthermore, a dispersion liquid in which fibrous carbon is dispersed may be sprayed on the lithium compound. When the sprayed dispersion dries, fibrous carbon adheres to the surface of the lithium compound.

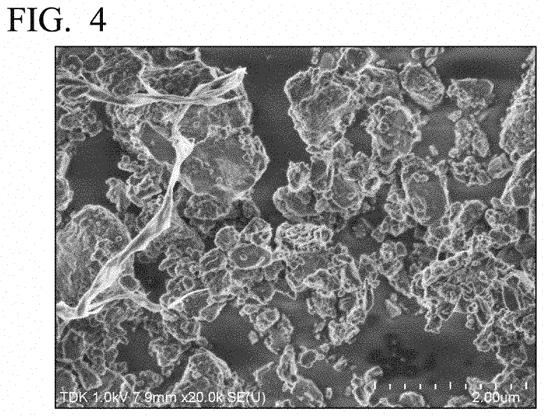

A wet method does not add mechanical energy. For this reason, when the wet method is utilized, the fibrous carbon adheres to the surface of the lithium compound to cling to the surface. When the wet method is utilized, there is less damage to the fibrous carbon and the lithium compound as compared with a case in which mechanical energy such as shear force and shear stress is used. FIG. 3 is a diagram of the composite powder prepared through the wet method captured through a scanning electron microscope. FIG. 4 is a diagram of a composite powder prepared through a mechanochemical method captured through a scanning electron microscope. The mechanochemical method is an example of a compounding process using mechanical energy.

As shown in FIG. 3, in the composite powder mixed as a compound through the wet method, fibrous carbon is clinging to the surface of the lithium compound. The lithium compound and fibrous carbon have not been significantly damaged during the producing process and maintain their pre-producing state.

On the other hand, as shown in FIG. 4, the composite powder mixed as a compound through the mechanochemical method is not mixed as a compound so that fibrous carbon clings to the surface of the lithium compound. Some of the lithium compounds are crushed by the mechanical energy during the production of the composite powder. Furthermore, as can be confirmed as a band-shaped substance in the upper left of FIG. 4, the fibrous carbon is bundled by mechanical energy.

An average particle size of the composite powder is, for example, 0.5 μm or more and 10 μm or less, preferably 0.5 μm or more and 8 μm or less, and more preferably 1.0 μm or more and 5 μm or less. Since the pores 2 are formed by the decomposition of the lithium compound of the composite powder, the average particle size of the composite powder is substantially the same as the average diameter of the pores 2.

Subsequently, the solvent is removed from the positive electrode slurry. For example, the positive electrode current collector 22 coated with the positive electrode slurry may be dried in an atmosphere of 80° C. to 150° C. Through such a procedure, the positive electrode 20 in which the positive electrode active material layer 24 is formed on the positive electrode current collector 22 is obtained.

The positive electrode on which the positive electrode active material layer 24 is formed may be pressed by a roll press device or the like if necessary. A linear pressure of the roll press varies depending on the material used, but is adjusted so that the density of the positive electrode active material layer 24 becomes a prescribed value. A relationship between a density of the positive electrode active material layer 24 and the linear pressure is obtained by a preliminary study based on the relationship with the material ratio constituting the positive electrode active material layer 24.

Also, the positive electrode 20 is cleaned. The cleaning is performed with a solvent in which the lithium compound can be dissolved. If the cleaning is performed, some of the lithium compounds in the composite powder are removed. The term “removed” is not limited to the fact that the removal is fully completed, but at least a part thereof may be removed. If the lithium compound is removed, the carbon network clinging to the surface of the lithium compound remains. The pores 2 are formed in the place in which the lithium compound is present. At least a part of the lithium compound may remain without decomposition and may remain in the state of a composite powder in which the lithium compound and the fibrous carbon are mixed as a compound.

Subsequently, the negative electrode 30 is prepared. The negative electrode 30 can be prepared in the same manner as the positive electrode 20. At least one surface of the negative electrode current collector 32 is coated with a paste-like negative electrode slurry. The negative electrode slurry is a paste obtained by mixing the negative electrode active material, the binder, the conductive auxiliary agent, and the solvent. The negative electrode 30 is obtained by coating the negative electrode current collector 32 with the negative electrode slurry and drying the negative electrode slurry.

Subsequently, the power generation element 40 is prepared by laminating the separator 10 so that the separator 10 is located between the prepared positive electrode 20 and negative electrode 30. When the power generation element 40 is a wound body, the positive electrode 20, the negative electrode 30, and the separator 10 are wound around one end side thereof as an axis.

Subsequently, the power generation element 40 is sealed in the exterior body 50. The non-aqueous electrolytic solution is injected into the exterior body 50. The non-aqueous electrolytic solution is impregnated into the power generation element 40 by injecting the non-aqueous electrolytic solution and then reducing the pressure, heating, or the like. When the exterior body 50 is sealed by applying heat or the like, the lithium ion secondary battery 100 can be obtained.

After that, the prepared lithium ion secondary battery 100 is aged (initial charge/discharge). Defective products can be removed by aging.

When the lithium ion secondary battery 100 according to the first embodiment has a carbon network made of fibrous carbon, a conductive path is secured in the positive electrode active material layer 24. The carbon network dissipates heat generated during charging and discharging under high output conditions.

Also, pores 2 are formed inside the carbon network. The pores 2 relieve the stress associated with the expansion and contraction of the positive electrode active material. The lithium ion secondary battery 100 according to the first embodiment is not easily affected by stress due to a change in volume of the positive electrode active material, and can maintain an ion path and a conductive path in the positive electrode active material layer 24. As a result, the lithium ion secondary battery 100 according to the first embodiment has excellent cycle characteristics.

Although the embodiments of the present invention have been described in detail above with reference to the drawings, each constitution and a combination thereof in each embodiment are examples and the constitutions can be added, omitted, replaced, and other changes are possible without departing from the gist of the present invention.

### EXAMPLES

### “Example 1”

### <Preparation of Composite Powder>

80 parts by mass of Li₂CO₃ as a lithium compound and 20 parts by mass of carbon nanotubes (CNTs) as fibrous carbon were prepared. An average particle size of the lithium compound was 1 μm. Am average diameter of the carbon nanotubes was 0.6 nm and an average length thereof was 10 μm.

Subsequently, a solution in which carbon nanotubes were dispersed was sprayed on this lithium compound. When the dispersion was dried, a composite powder in which carbon nanotubes were attached to the surface of the lithium compound was prepared.

### <Preparation of Positive Electrode>

Subsequently, the composite powder, the positive electrode active material, the conductive auxiliary agent, and the binder were mixed to prepare a positive electrode mixture. Lithium cobalt oxide (LiCoO₂) was used as the positive electrode active material, carbon black was used as the conductive auxiliary agent, and polyvinylidene fluoride (PVDF) was used as the binder. A mass ratio of the positive electrode active material, the composite powder, the conductive auxiliary agent, and the binder was 93:3:2:2. This positive electrode mixture was dispersed in N-methyl-2-pyrrolidone to prepare a positive electrode slurry (slurry preparation step). Furthermore, one surface of a positive electrode current collector made of an aluminum foil having a thickness of 15 μm was coated with a positive electrode slurry so that an amount of the positive electrode active material to be applied was 9.0 mg/cm² (coating step). After coating, the positive electrode slurry was dried at 100° C. to remove the solvent and the obtained coating film was rolled to obtain a positive electrode active material layer.

Also, the prepared positive electrode was washed with water. An excessive amount of water capable of sufficiently dissolving the lithium compound was prepared. When the positive electrode was washed with water, Li₂CO₃ which is a lithium compound was removed.

### <Preparation of Negative Electrode>

A negative electrode mixture was prepared by mixing the negative electrode active material, the conductive material, and the binder. The negative electrode active material was silicon, the conductive material was carbon black, and the binder was carboxymethyl cellulose (CMC) and styrene-butadiene rubber (SBR). A mass ratio of the negative electrode active material, the conductive material, and the binder was 90:5:5. This negative electrode mixture was dispersed in distilled water to prepare a negative electrode slurry. Furthermore, one surface of a copper foil having a thickness of 10 μm was coated with the negative electrode slurry. After coating, the negative electrode slurry was dried at 100° C. to remove the solvent to form a negative electrode active material layer.

### <Preparation of Cell>

The prepared negative electrode and positive electrode were punched into a prescribed shape, laminated alternately via a polypropylene separator having a thickness of 25 μm, and 9 negative electrodes and 8 positive electrodes were laminated to prepare a laminated body.

An opening was formed by inserting the laminated body into an exterior body made of an aluminum laminated film and heat-sealing it except for one surrounding place. A non-aqueous electrolyte solution was injected into the exterior body. As the non-aqueous electrolytic solution, 1.0 mol/L of lithium hexafluorophosphate (LiPF₆) was dissolved in a solvent in which an equal amount of ethylene carbonate (EC) and dimethyl carbonate (DEC) were mixed. Furthermore, 5 wt % fluoroethylene carbonate and 0.01 wt % vinylene carbonate were added to the non-aqueous electrolytic solution. In addition, the remaining one place was sealed with a heat seal while reducing the pressure with a vacuum sealer.

### <Overcharge Test>

An overcharge test was performed on the prepared lithium ion secondary battery and a maximum arrival temperature of the lithium ion secondary battery was measured. In the overcharge test, a battery at room temperature and a state of charge (SOC) of 100% was charged with a current of 0.7 C and held at 10 V for 90 minutes. A temperature was measured by attaching a thermocouple to a terminal. As a result, a maximum arrival temperature of the lithium ion secondary battery of Example 1 was 75° C.

### <Decomposition Evaluation>

Also, the lithium ion secondary battery prepared under the same conditions was disassembled and the positive electrode active material layer was captured through a scanning electron microscope. As a result, it was confirmed that a carbon network made of fibrous carbon was formed in the positive electrode active material layer. It was also confirmed that the space surrounded by the carbon network was a pore. It was confirmed that the average diameter of the pores was 1 μm, which was substantially the same as the average particle size of the lithium compound.

### Example 2

Example 2 is different from Example 1 in that an average particle size of a lithium compound used in a composite powder was 8 μm. Other conditions were the same as in Example 1 and an overcharge test and a decomposition evaluation were performed.

A maximum arrival temperature of a lithium ion secondary battery of Example 2 was 80° C. In Example 2, it was confirmed that a carbon network made of fibrous carbon was formed in the positive electrode active material layer and it was confirmed that the average diameter of the pores surrounded by the carbon network was 8 μm.

### Example 3

Example 3 is different from Example 2 in that an average diameter of carbon nanotubes used in a composite powder was 150 μm. Other conditions were the same as in Example 1 and an overcharge test and a decomposition evaluation were performed.

A maximum arrival temperature of a lithium ion secondary battery of Example 3 was 82° C. In Example 3, it was confirmed that a carbon network made of fibrous carbon was formed in the positive electrode active material layer and it was confirmed that the average diameter of the pores surrounded by the carbon network was 8 μm.

### Comparative Example 1

Comparative Example 1 is different from Example 1 in that carbon nanotubes are directly added to a positive electrode slurry without preparing a composite powder. Other conditions were the same as in Example 1 and an overcharge test and a decomposition evaluation were performed.

A maximum arrival temperature of a lithium ion secondary battery of Comparative Example 1 was 121° C. In Comparative Example 1, fibrous carbon was confirmed in the positive electrode active material, but a carbon network was not confirmed. Although pores were confirmed, a carbon network was not formed around the pores. An average diameter of pores was 1 μm.

### Comparative Example 2

Comparative Example 2 is different from Example 1 in that carbon black (CB) is used instead of fibrous carbon when the composite powder is prepared. Other conditions were the same as in Example 1 and an overcharge test and a decomposition evaluation were performed.

A maximum arrival temperature of a lithium ion secondary battery of Comparative Example 2 was 134° C. In Comparative Example 2, a carbon film in which carbon black was folded in the positive electrode active material was confirmed. A carbon film surrounded pores. It was confirmed that an average diameter of the pores was 1 μm, which was substantially the same as the average particle size of the lithium compound.

### Comparative Example 3

Comparative Example 3 is different from Comparative Example 2 in that a composite powder was not prepared and an average particle size of a lithium compound was 8 μm. That is to say, carbon black was added directly to a positive electrode slurry. Other conditions were the same as in Example 1 and an overcharge test and a decomposition evaluation were performed.

A maximum arrival temperature of a lithium ion secondary battery of Comparative Example 3 was 139° C. In Comparative Example 3, pores were confirmed, but a carbon network was not formed around the pores. An average diameter of the pores was 8 μm.

As mentioned above, the results of Examples 1 to 3 and Comparative Examples 1 to 3 are summarized in Table 1 below.

TABLE 1

| | | | | | Maximum |
|---|---|---|---|---|---|
| | | | | | arrival |
| | | | | Average | temperature |
| | Composite particle | | CNT | diameter | of over- |
| | Lithium | Fibrous | diameter | of pores | charge test |
| | compound | carbon | (nm) | (μm) | (° C.) |
| Example 1 | Li₂CO₃ | CNT | 0.6 | 1 μm | 75 |
| Example 2 | Li₂CO₃ | CNT | 0.6 | 8 μm | 80 |
| Example 3 | Li₂CO₃ | CNT | 150 | 8 μm | 82 |
| Comparative | Li₂CO₃ | — | 0.6 | 1 μm | 121 |
| Example 1 | | | | | |
| Comparative | Li₂CO₃ | CB | — | 1 μm | 134 |
| Example 2 | | | | | |
| Comparative | Li₂CO₃ | — | — | 8 μm | 139 |
| Example 3 | | | | | |

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Fibrous carbon
2 Pore
10 Separator
20 Positive electrode
22 Positive electrode current collector
24 Positive electrode active material layer
30 Negative electrode
32 Negative electrode current collector
34 Negative electrode active material layer
40 Power generation element
50 Exterior body
52 Metal foil
54 Resin layer
60, 62 Terminal
100 Lithium ion secondary battery

What is claimed is:

1. A positive electrode for a lithium ion secondary battery comprising:
a current collector; and
a positive electrode active material layer in contact with at least one surface of the current collector, wherein
the positive electrode active material layer contains a plurality of positive electrode active materials and a plurality of fibrous carbons,
the positive electrode active material layer has a plurality of pores therein,
at least a part of the plurality of fibrous carbons is intertwined with each other to form a carbon network, and
the carbon network is formed on a surface facing one of the plurality of pores.

2. The positive electrode for a lithium ion secondary battery according to claim 1,
wherein an average diameter of the plurality of fibrous carbons is 0.3 nm or more and 100 nm or less.

3. The positive electrode for a lithium ion secondary battery according to claim 1,
wherein an average diameter of the plurality of pores is 0.5 μm or more and 5 μm or less.

4. A lithium ion secondary battery, comprising:
the positive electrode for a lithium ion secondary battery according to claim 1.
